(19) United States
(12) Patent Application Publication
(10) Pub. No.: US 2020/0086359 A1
(43) Pub. Date: Mar. 19, 2020

(54) Keyboard cleaning accessory

(71) Applicant: Yudong Zhu, Wuhan City (CN)

(72) Inventor: Yudong Zhu, Wuhan City (CN)

(21) Appl. No.: 16/690,102

(22) Filed: Nov. 20, 2019

(30) Foreign Application Priority Data
Apr. 25, 2019 (CN) 2019103377426

(51) Int. Cl. B08B 5/02; B08B 7/02

(52) U.S. Cl. CPC B08B 5/02; B08B 7/02

(57) ABSTRACT

A keyboard cleaning accessory of the present invention includes a shell body, a first cavity is disposed in the shell body, a second cavity is disposed in a left end wall of the first cavity, and a left cavity wall is disposed in the second cavity The invention has a third cavity; the keyboard cleaning accessory of the invention has simple and clear operation, is sensitive to reaction and has high cleaning efficiency; meanwhile, the device of the invention has a storage function, is safe and reliable, and has strong practicability.

### CROSS-REFERENCES TO RELATED APPLICATIONS

The present application claims priority from Chinese application No. 2019103377426 filed on Apr. 25, 2019 which is hereby incorporated by reference in its entirety.

### TECHNICAL FIELD

The present invention relates to the field of computer accessory, in particular to a keyboard cleaning accessory.

### BACKGROUND OF THE INVENTION

When cleaning the keyboard, it is often necessary to remove the keycap to clean the dust and debris in the keyboard gap. It takes time and effort to remove and install the keycap, and the manual cleaning of the keyboard is inefficient. In addition, a storage device is required for storage when the keyboard is not in use. Prevent dust accumulation; therefore, it is necessary to design a keyboard cleaning accessory to solve the above problem.

### BRIEF SUMMARY OF THE INVENTION

The technical problem to be solved by the present invention is to provide a keyboard cleaning accessory which can solve the problems in the prior art described above.

The present invention is achieved by the following technical solution: a keyboard cleaning accessory of the present invention, comprising a shell body, a first cavity is disposed in the shell body, and a second cavity is disposed in the left end wall of the first cavity a third cavity is disposed in the left end wall of the second cavity, and a first rotating shaft extending left and right is disposed between the third cavity and the first cavity, and the right end of the first rotating shaft is fixed a first pulley is fixedly disposed on a left end of the first rotating shaft, a first sliding slot is disposed on the rear side end wall of the first cavity, and a slider is disposed in the first sliding slot. An internal thread engaged with the screw is disposed in the block, and a fixing block is fixed on a top surface of the slider, and a spline sleeve extending left and right is disposed in the fixing block, and the second cavity and the second cavity a spline shaft that is engaged with the spline sleeve is disposed between the cavities, and a long rod is fixedly disposed at a left end of the spline shaft, and a second chute is disposed through the left and right sides of the long rod, the third a rotation between the cavity and the second cavity is provided with a second rotating shaft extending left and right, and a right end of the second rotating shaft is fixedly provided with a disc The right end surface of the disc is fixedly disposed to slide in the second sliding slot, and the second end of the second rotating shaft is fixedly provided with a second pulley, and a motor is arranged in the bottom wall of the first cavity, and the third a first drive shaft electrically connected to the motor is disposed in a right end wall of the cavity, and a third pulley is fixedly disposed on a left end of the first drive shaft, the third pulley, the first pulley and the second The pulley is coupled by a belt drive; therefore, the motor can drive the slider and the fixed block to slide left and right in the first cavity.

Preferably, a fourth cavity is disposed in the right end wall of the motor, a first through hole is formed in the fourth cavity and the first cavity, and the bottom wall of the fourth cavity is connected a ventilation hole having a downward opening, a check valve fixed in the air inlet hole, a fifth cavity in the right end wall of the fourth cavity, the fourth cavity and the fifth cavity Rotating between the second driving shaft and the second driving shaft, wherein the second driving shaft in the fourth cavity is fixedly provided with a turbine, and the fixing block is provided with an opening and upward rotating cavity, a blowing needle tube fixedly connected to the spline sleeve is disposed in the rotating chamber, and the blowing needle tube is provided with an L-shaped air groove with an opening upward, and the right end wall of the rotating chamber is connected with an opening to the right, a second through hole, wherein the second through hole is provided with an intake pipe connecting the L-shaped gas groove and the first through hole; thus, the turbine rotation compresses air and is transported to the same through the intake pipe Said in the L-shaped gas trough.

Preferably, the top wall of the first cavity is connected with a keyboard placement slot with an opening upward, and the keyboard placement slot is symmetrically slidably provided with a baffle, and the two baffles respectively and the left and right end faces of the keyboard placement slot A spring is connected between the two baffles, and a keyboard base is disposed between the two baffles. The top surface of the keyboard base is provided with a key cap. The left end of the bottom wall of the keyboard is fixed with a receiver, and the keyboard is placed at the bottom of the slot, a transmitter is fixedly disposed at a right end of the wall, the receiver and the transmitter are respectively electrically connected to the motor, and a sixth cavity is communicated in a right end wall of the keyboard placement slot, the sixth cavity is a third rotating shaft extending upward and downward is disposed between the fifth cavity, a cam is fixedly fixed to the top end of the third rotating shaft, a first bevel gear is fixedly disposed at a bottom end of the third rotating shaft, and a right end of the second driving shaft is fixed A second bevel gear meshing with the first bevel gear is provided; thus, the motor drives the cam to rotate, the cam shaking the keyboard base to the left and right.

In summary, the keyboard cleaning accessory of the present invention has simple and clear operation, is sensitive to reaction, and has high cleaning efficiency. Meanwhile, the device of the present invention has a storage function, is safe and reliable, and has strong practicability.

### BRIEF DESCRIPTION OF THE DRAWINGS

For ease of description, the present invention is described in detail by the following specific embodiments and the accompanying drawings.

FIG. 1 is a schematic view showing the overall structure of a keyboard cleaning accessory of the present invention;

FIG. 2 is a schematic enlarged view of A of FIG. 1. FIG.

### DETAILED DESCRIPTION OF THE INVENTION

All of the features disclosed in this specification, or steps in all methods or processes disclosed, may be combined in any manner other than mutually exclusive features and/or steps.

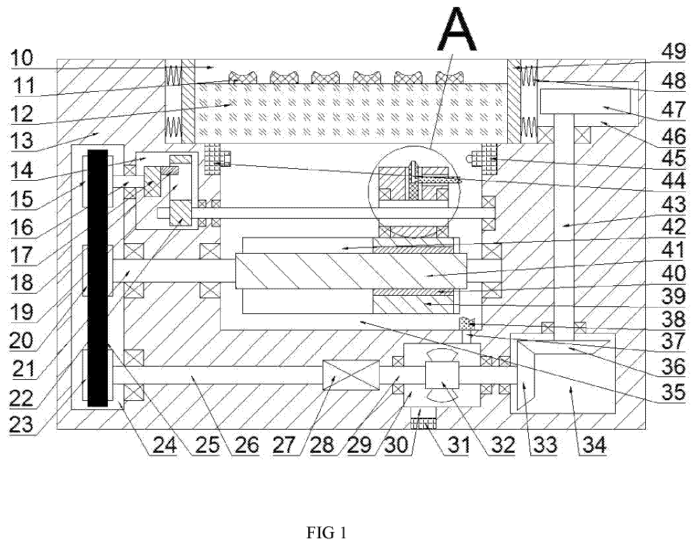

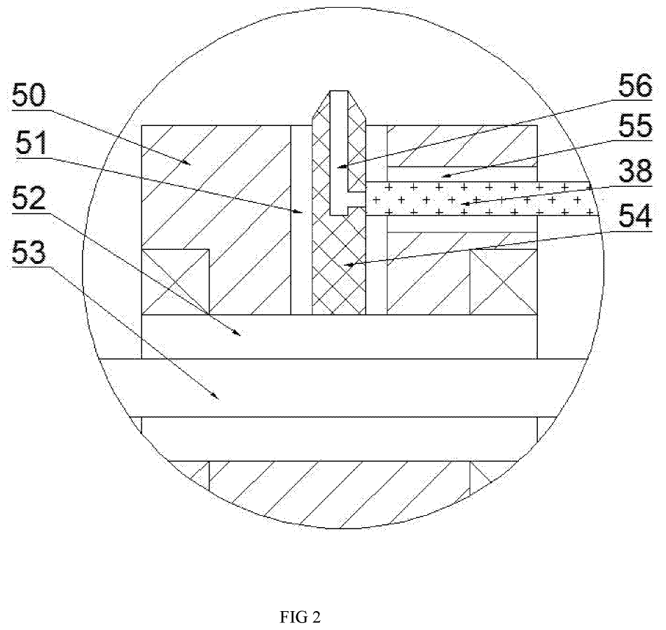

The present invention will now be described in detail with reference to FIGS. 1-2. Here, for convenience of description, the orientations described below are now defined as follows: the up, down, left, and right front and rear directions described below coincide with the up, down, left, and right front and rear directions of the projection relationship of FIG. 1 itself.

As shown in FIG. 1-2, a keyboard cleaning accessory of the present invention includes a shell body 13 having a first cavity 35 therein, and a second cavity in the left end wall of the first cavity 35, a third cavity 24 is defined in the left end wall of the second cavity 14, and a first rotating shaft 21 extending left and right is disposed between the third cavity 24 and the first cavity 35, a screw 41 is fixedly disposed at a right end of the first rotating shaft 21, and a first pulley 20 is fixedly disposed at a left end of the first rotating shaft 21, and a first sliding slot 42 is communicated with the rear end wall of the first cavity 35. A slider 39 is disposed in the first sliding slot 42. The slider 39 is provided with an internal thread 40 that engages with the screw 41. The top surface of the slider 39 is fixedly provided with a fixing block 50, and the fixing block is fixed, a spline sleeve 52 extending between the left and right is provided in the inner portion of the 50, and a spline shaft 53 engaging with the spline sleeve 52 is disposed between the second cavity 14 and the first cavity 35. The left end of the key shaft 53 is fixedly provided with a long rod 22, and the second rod 19 is disposed in the left and right sides of the long rod 22, and the third cavity 24 and the second cavity 14 are rotated to extend left and right. Second shaft 16, The right end of the second rotating shaft 16 is fixedly provided with a disc 17, and the right end surface of the disc 17 is fixedly disposed with a sliding portion 18 of the second sliding slot 19, and the second end of the second rotating shaft 16 is fixedly provided with a second pulley 15. A motor 27 is disposed in a bottom wall of the first cavity 35, and a first driving shaft 26 electrically connected to the motor 27 is disposed in a right end wall of the third cavity 24, and the left end of the first driving shaft 26 is Fixedly provided with a third pulley 23, the third pulley 23, the first pulley 20 and the second pulley 15 are drivingly connected by a belt 25; therefore, the motor 27 can drive the slider 39 and the The fixing block 50 slides left and right in the first cavity 35.

Advantageously, a fourth cavity 29 is defined in the right end wall of the motor 27, and a first through hole 37 is formed in communication between the fourth cavity 29 and the first cavity 35, the fourth cavity The bottom wall communicates with an air inlet opening 30 having a downward opening, a check valve 31 is fixed in the air inlet hole 30, and a fifth cavity 34 is disposed in the right end wall of the fourth cavity 29, A second driving shaft 28 electrically connected to the motor 27 is disposed between the fourth cavity 29 and the fifth cavity 34, and the second driving shaft 28 in the fourth cavity 29 is fixed A rotating shaft 51 is defined in the fixing block 50, and a rotating air chamber 54 is fixedly connected to the spline sleeve 52. The air blowing needle tube 54 is disposed in the rotating chamber 51. An L-shaped air groove 56 having an opening upward is disposed, and a right end wall of the rotating cavity 51 communicates with a second through hole 55 having an opening to the right, and the second through hole 55 is provided with a connection between the L-shaped air groove 56 and The intake pipe 38 of the first through hole 37; thus, the turbine 32 rotates to compress air and is carried into the L-shaped gas groove 56 through the intake pipe 38.

Advantageously, the top wall of the first cavity 35 communicates with a keyboard placement slot 10 having an opening upward, and the keyboard placement slot 10 is symmetrically slidably disposed with a baffle 49, and the two baffles 49 respectively and the keyboard A spring 48 is connected between the left and right end faces of the slot 10, and a keyboard base 12 is disposed between the two baffles 49. The top surface of the keyboard base 12 is provided with a key cap 11, and the keyboard is placed at the left end of the bottom wall of the slot 10. A receiver 44 is fixedly disposed, and a transmitter 45 is fixedly disposed at a right end of the bottom wall of the keyboard placement slot 10. The receiver 44 and the transmitter 45 are respectively electrically connected to the motor 27, and the keyboard is placed at the right end of the slot 10. A sixth cavity 46 is disposed in the wall, and a third rotating shaft 43 extending upward and downward is disposed between the sixth cavity 46 and the fifth cavity 34. The third rotating shaft 43 is fixedly provided with a cam at a top end thereof 47. The bottom end of the third rotating shaft 43 is fixedly provided with a first bevel gear 36, and the second end of the second driving shaft 28 is fixedly provided with a second bevel gear 33 meshing with the first bevel gear 36; The motor 27 drives the cam 47 to rotate, and the cam 47 causes the keyboard base 12 to shake left and right.

In the following, the applicant will refer to the drawings and the specific composition of a keyboard cleaning accessory of the present application described above to describe its usage method in detail:

In the initial state, the transmitter 45 emits laser light into the receiver 44, and when the laser reception is unobstructed, the motor 27 is not energized;

When the keyboard base 12 is placed in the keyboard placement slot 10, the keycap 11 is located at the top of the keyboard placement slot 10. At this time, the device is in a normal keyboard storage state, and the keyboard is stored and stored;

When the keyboard base 12 is reversely placed in the keyboard placement slot 10, the keycap 11 is located in the first cavity 35 and blocks the laser light emitted by the transmitter 45, that is, the motor 27 is energized, and the motor 27 drives the first drive shaft 26 and The second driving shaft 28 rotates, the first driving shaft 26 drives the third pulley 23 to rotate, and the third pulley 23 drives the first pulley 20 and the second pulley 15 to rotate through the belt 25, and the first pulley 20 rotates to drive the screw 41 to rotate, and the internal thread 40 cooperates with the slider 39 to drive the slider 39 to slide in the first sliding slot 42. The first sliding slot 42 drives the fixing block 50 and the spline sleeve 52 to slide on the spline shaft 53. At this time, the blowing needle 54 performs lateral movement. At the same time, the second pulley 15 drives the disk 17 to rotate, and the disk 17 drives the 18 to slide in the second sliding slot 19, so that the long rod 22 swings back and forth, and the long rod 22 drives the spline shaft 53 and the spline sleeve 52. The front and rear swings, that is, the air blowing needle 54 swings back and forth, at which time the air blowing needle 54 swings back and forth and slides laterally. At the same time, the second driving shaft 28 drives the turbine 32 to rotate, and the turbine 32 sends the compressed air to the L-shaped air tank through the air inlet pipe 38, 56 is ejected, that is, the entire area of the keycap 11 is compressed Injection, clears the keyboard interstitial impurities;

At the same time, the second driving shaft 28 drives the second bevel gear 33 to rotate, the second bevel gear 33 drives the first bevel gear 36 and the cam 47 to rotate, the cam 47 drives the baffle 49 to repeatedly slide left and right, and the baffle 49 drives the keyboard base 12 to shake left and right. The solid impurities adhering to the keyboard base 12 are shaken out, and the cleaning efficiency is increased.

In summary, the keyboard cleaning accessory of the present invention has simple and clear operation, is sensitive to reaction, and has high cleaning efficiency. Meanwhile, the device of the present invention has a storage function, is safe and reliable, and has strong practicability.

The above is only the specific embodiment of the invention, but the scope of the invention is not limited thereto, and any changes or substitutions that are not thought of by the creative work are included in the scope of the invention.

1. A keyboard cleaning accessory according to the present invention includes a housing body, wherein: a first cavity is disposed in the housing body, and a second cavity is disposed in a left end wall of the first cavity, the second cavity a third cavity is disposed in the left end wall, and a first rotating shaft extending left and right is disposed between the third cavity and the first cavity, and a screw is fixedly disposed at a right end of the first rotating shaft, the first a first pulley is fixedly disposed on a left end of the rotating shaft, a first sliding slot is disposed on the rear side end wall of the first cavity, and a slider is disposed in the first sliding slot, and the slider is provided with the The inner thread of the screw meshing, the top surface of the slider is fixedly provided with a fixing block, and the fixing block is rotated to provide a spline sleeve extending left and right, and the second cavity is rotated between the second cavity and the first cavity a spline shaft engaging with the spline sleeve, wherein the left end of the spline shaft is fixedly provided with a long rod, and the second rod is disposed in the left and right sides of the long rod, and the third cavity is Rotating between the second cavity is provided with a second rotating shaft extending left and right, and a right end of the second rotating shaft is fixedly provided with a disc, and the right end of the disc a second pulley is fixedly disposed on the left end of the second rotating shaft, and a motor is disposed in the bottom wall of the first cavity, and the third cavity is rotated in the right end wall a first driving shaft is connected to the motor, and a third pulley is fixedly disposed at a left end of the first driving shaft, and the third pulley, the first pulley and the second pulley are connected by a belt drive; Therefore, the motor can drive the slider and the fixed block to slide left and right in the first cavity.

2. The keyboard cleaning accessory according to claim 1, wherein a fourth cavity is disposed in the right end wall of the motor, and a first gap is formed between the fourth cavity and the first cavity, a through hole, the bottom wall of the fourth cavity is connected with an air inlet hole having an opening downward, a check valve is fixed in the air inlet hole, and a fifth cavity is disposed in the right end wall of the fourth cavity a second driving shaft electrically connected to the motor is disposed between the fourth cavity and the fifth cavity, and a turbine is fixed on the second driving shaft in the fourth cavity An opening chamber with an opening upward is disposed in the fixing block, and a blowing needle tube fixedly connected to the spline sleeve is disposed in the rotating chamber, and an L-shaped air groove with an opening upward is disposed in the blowing needle tube. The right end wall of the rotating chamber communicates with a second through hole having an opening to the right, and the second through hole is provided with an intake pipe connecting the L-shaped gas groove and the first through hole; thus, the turbine Rotation compresses the air and transports it through the intake manifold into the L-shaped gas channel.

3. The keyboard cleaning accessory according to claim 1, wherein the top wall of the first cavity is connected with a keyboard placement slot with an opening upward, and the keyboard placement slot is symmetrically slidably provided with a baffle plate. A spring is connected between the baffle and the left and right end faces of the keyboard placement slot, and a keyboard base is disposed between the two baffles, and a top surface of the keyboard base is provided with a key cap, and the keyboard is placed at the bottom of the slot A receiver is fixedly disposed at a left end of the wall, and a transmitter is fixedly disposed at a right end of the bottom wall of the keyboard. The receiver and the transmitter are respectively electrically connected to the motor, and the right end wall of the keyboard placement slot is connected a sixth cavity, a third rotating shaft extending upwardly and downwardly between the sixth cavity and the fifth cavity, a top end of the third rotating shaft is fixedly provided with a cam, and a bottom end of the third rotating shaft is fixedly disposed a first bevel gear, a second bevel gear fixedly coupled to the first bevel gear at a right end of the second driving shaft; thus, the motor drives the cam to rotate, and the cam causes the keyboard base to be left and right shake.
